(19) United States
(12) Patent Application Publication
(10) Pub. No.: US 2002/0176085 A1
(43) Pub. Date: Nov. 28, 2002

(54) Feedback position control system and method for an interferometer

(76) Inventor: Gregory S. Hill, Santa Rosa, CA (US)

Correspondence Address: AGILENT TECHNOLOGIES, INC, Legal Department, 51U-PD, Intellectual Property Administration, P.O. Box 58043, Santa Clara, CA, 95052-8043, US

(21) Appl. No.: 09/865,317

(22) Filed: May 25, 2001

(51) Int. Cl. G01B 9/02

(52) U.S. Cl. 356/452

(57) ABSTRACT

A feedback position control system and method enable an optical element in a variable arm of an interferometer to be varied according to a predesignated motion profile. The system and method detect a reference optical signal that varies in intensity according to a position of the optical element in the variable arm. The system and method receive the detected reference optical signal, derive a motion profile from the detected reference optical signal and compare the derived motion profile to the predesignated motion profile to generate a control signal based on a deviation between the derived motion profile and the predesignated motion profile. The control signal is used to adjust the position of the optical element in the variable arm of the interferometer to minimize the deviation between the derived motion profile and the predesignated motion profile.

### BACKGROUND AND SUMMARY OF THE INVENTION

Optical interferometers are used to measure the wavelength content of applied optical signals relative to a known wavelength of a reference optical signal. For applied optical signals that include modulation or other multi-wavelength components, measurement accuracy and wavelength discrimination of the interferometer are improved by varying the position of an optical element in a variable arm of the interferometer according to a predesignated motion profile. Prior art position control systems that vary the position of the optical element in an open loop fashion, do not ensure that the motion of the optical element conforms to the predesignated motion profile. When the motion of the optical element deviates from the predesignated motion profile, measurement accuracy and wavelength discrimination of the interferometer are compromised. Accordingly, there is a need to vary the position of an optical element in the variable arm of an interferometer so that the motion of the optical element conforms to a predesignated motion profile. This need is met by a feedback position control system and method constructed according to the embodiments of the present invention.

### BRIEF DESCRIPTION OF THE DRAWINGS

FIG. 1 shows a prior art position control system.

FIGS. 2A-2D show a feedback position control system constructed according to a first embodiment of the present invention.

FIG. 3 is a flow diagram of a feedback position control method constructed according to a second embodiment of the present invention.

### DETAILED DESCRIPTION OF THE EMBODIMENTS

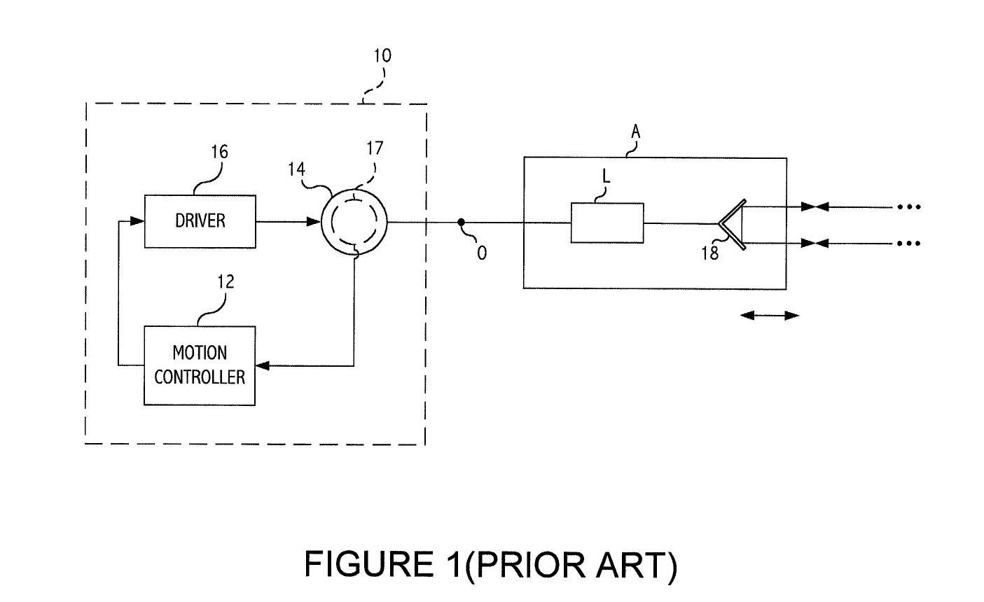

FIG. 1 shows a prior art position control system 10 including a motion controller 12, a motor 14, a driver 16, and an encoder 17 coupled to the motor 14. By coupling an output O of the control system 10 to an optical element 18 in a variable arm A of an interferometer (not shown) through a linkage L, position of the optical element 18 can be varied, enabling the interferometer to measure wavelength content of an applied optical signal relative to a known wavelength of a reference optical signal. When the applied optical signal includes modulation or other multi-wavelength components, measurement accuracy and wavelength discrimination of the interferometer are improved by varying the position of the optical element 18 according to a predetermined motion profile.

Although a local feedback loop formed by the motion controller 12, the motor 14, the driver 16, and the encoder 17 ensures that motion at the output O of the control system 10 is accurately controlled, the optical element 18 is controlled beyond the output O of the control system 10 in an open loop fashion, making it difficult to accurately control the motion of the optical element 18. Hysteresis, backlash and other anomalies in a transfer function of the linkage L between the output O and the optical element 18 cause the motion of the optical element 18 to deviate from the predetermined motion profile, compromising the measurement accuracy and wavelength discrimination of the interferometer. The prior art position control system 10 also relies on the encoder 17 to sense the motion of the motor 14, which adds cost and complexity to this type of prior art position control system 10.

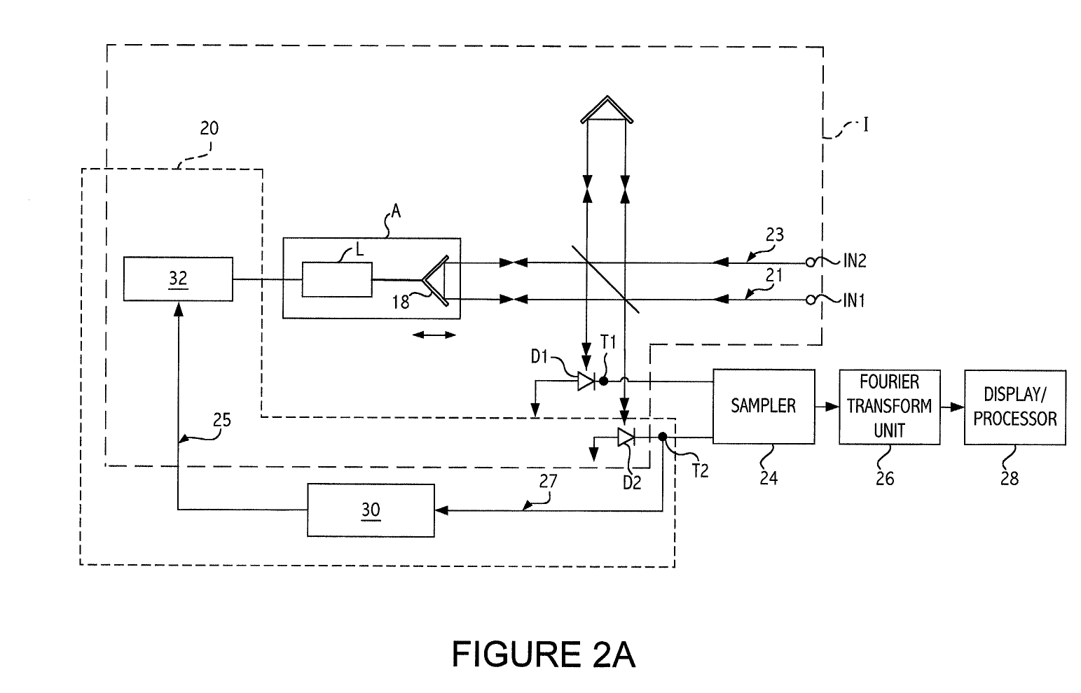

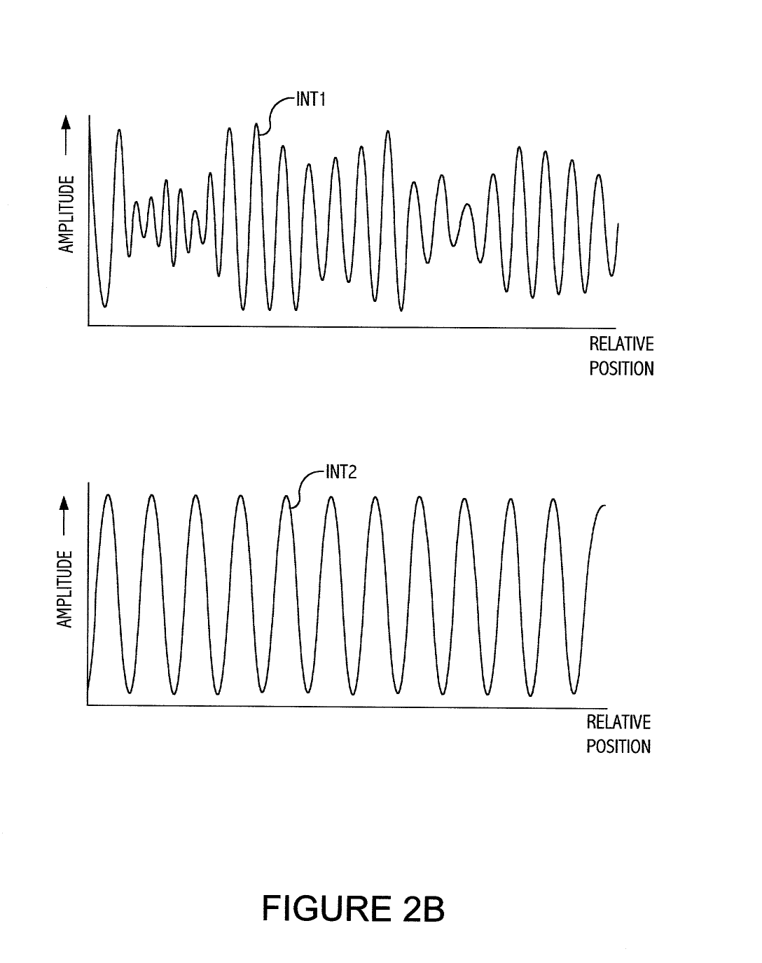

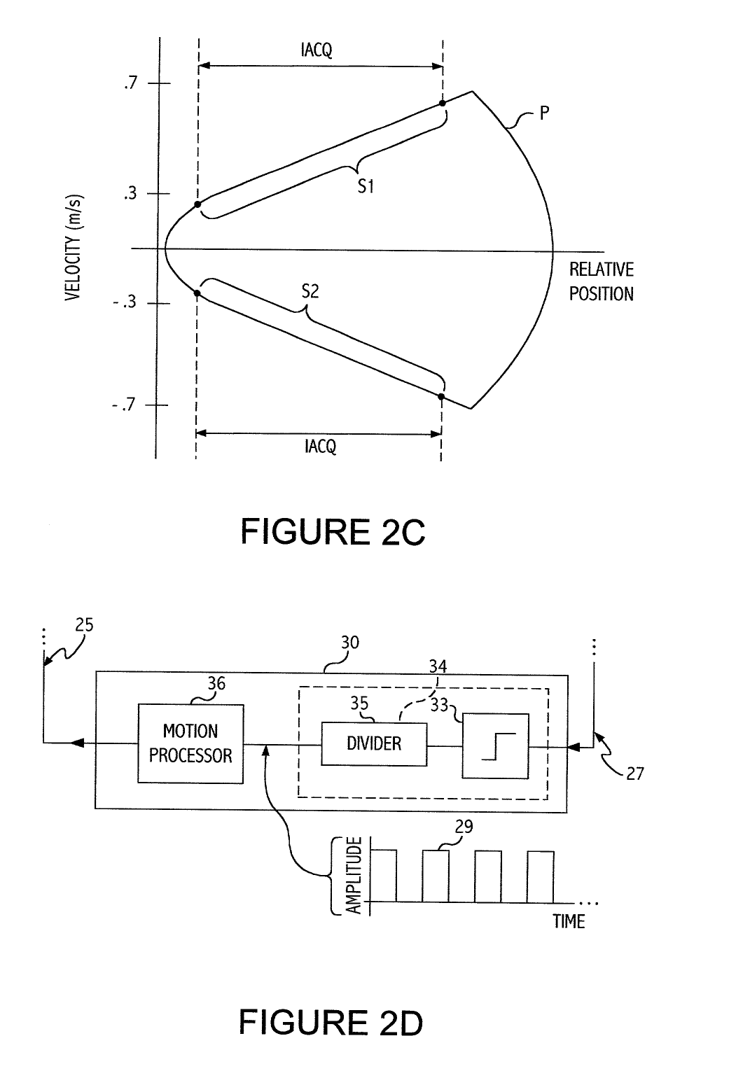

FIGS. 2A-2D show aspects of a feedback position control system 20 for an interferometer I constructed according to a first embodiment of the present invention. The interferometer I included in FIG. 2A is configured to measure wavelength content of an applied optical signal 21 at an input IN1 of the interferometer I relative to a known wavelength of a reference optical signal 23 at an input IN2 of the interferometer I. This type of interferometer I is described in Fiber Optic Test and Measurement, ISBN 0-13-534330-5, edited by Dennis Derickson, Chapter 4, pages 131-143. Typically, the measurement of wavelength content involves comparing an interferogram INT1 associated with the applied optical signal 21 to an interferogram INT2 associated with the reference optical signal 23, where the reference optical signal 23 at the input IN2 is supplied by a HeNe laser or other type of optical source. The interferograms INT1, INT2 (shown in FIG. 2B) result at terminals T1, T2 of the photodetectors D1, D2, respectively. Typically, a sampler 24, a Fourier Transform Unit 26, and a display/processor 28 are coupled to the photodetectors D1, D2 of the interferometer I and used to process and compare the interferograms INT1, INT2 so that the wavelength content of the applied optical signal 21 can be extracted from the interferograms INT1, INT2 and displayed.

The interferograms INT1, INT2 of FIG. 2B result from varying the position of an optical element 18, such as a corner cube or other reflector, in a variable arm A of the interferometer I of FIG. 2A. By varying the position of the optical element 18 according to a predesignated motion profile P (shown in FIG. 2C), the wavelength content of the applied optical signal 21 can be accurately measured, even when the applied optical signal 21 includes modulation or other multi-wavelength components. The predesignated motion profile P in this example indicates the velocity of the optical element 18 versus the relative position of the optical element 18 in the variable arm A of the interferometer I. This predesignated motion profile P includes a constant positive acceleration segment S1 and a constant negative acceleration segment S2. Overlapping one or more of segments S1, S2 of the predesignated motion profile P are acquisition intervals IACQ over which samples of the interferograms INT1, INT2 are acquired by the sampler 24. As alternatives to the example of the predesignated motion profile P shown in FIG. 2C, the predesignated motion profile P is one of a variety of contours indicating the velocity, acceleration or jerk of the optical element 18 versus relative position of the optical element 18, where the jerk is the time derivative of the acceleration of the optical element 18. Typically, the predesignated motion profile P is established according to the characteristics of the applied optical signal 21 and the parameters of the measurements performed by the interferometer I.

The feedback position control system 20 shown in FIG. 2A includes the photodetector D2 that provides the interferogram INT2 at the terminal T2 as a result of detecting the reference optical signal 23, where the reference optical signal 23 has an intensity that varies according to the position of the optical element 18 in the variable arm A of the interferometer I. A feedback processor 30 coupled to the photodetector D2 receives this detected reference optical signal 27 and derives a motion profile from the detected reference optical signal 27. The feedback processor 30 compares the derived motion profile to the predesignated motion profile P and generates a control signal 25 based on a deviation between the derived motion profile and the predesignated motion profile P. The control signal 25 is applied to an actuator 32 that adjusts the position of the optical element 18 in the variable arm A of the interferometer I to minimize the deviation between the derived motion profile and the predesignated motion profile P. The control signal 25 provides negative feedback within the feedback position control system 20 to minimize the deviation between the derived motion profile and the predesignated motion profile P.

Typically, the photodetector D2 and actuator 32 included in the feedback position control system 20 are those that are included in the interferometer I into which the feedback position control system 20 is integrated. In interferometers, the photodetector D2 is typically a photodiode or other optical element, sensor or system that generates electrical signals in response to optical illumination. In interferometers, the actuator 32 is typically a rotational motor with linkage L that converts rotational motion of the motor to linear motion, so that the optical element 18 in the variable arm A of the interferometer I is linearly translated. Alternatively, the actuator 32 is any other type of translation mechanism or apparatus suitable for translating the optical element 18 in response to an applied control signal 25.

The feedback processor 30 is implemented using analog hardware or digital hardware, or a combination of analog and digital hardware as shown in FIG. 2D. Alternatively, the feedback processor 30 receives samples of the interferogram INT2 from the sampler 24 and the feedback processor 30 is implemented in digital hardware, software, or a combination of digital hardware and software. In FIG. 2D the feedback processor 30, includes a waveform conditioner 34 and a motion processor 36. The waveform conditioner 34 receives the detected reference optical signal 27. From the detected reference optical signal 27, the waveform conditioner 34 generates a timing signal 29 having amplitude transitions that correspond to the position of the optical element 18 in the variable arm A of the interferometer I. The waveform conditioner 34 shown in FIG. 2D includes a squaring circuit 33, such as a threshold detector, edge detector, zero crossing detector or other types of waveform conditioning circuits, devices or systems capable of generating a timing signal 29 from the detected reference optical signal 27. A divider 35 is optionally included in the waveform conditioner to scale the timing of the amplitude transitions within the timing signal 29.

The motion processor 36 interfacing with the waveform conditioner 34 in this example is a PILOT MOTION PROCESSOR FOR BRUSHED SERVO MOTION CONTROL, part number MC3110 available from PERFORMANCE MOTION DEVICES, in Lexington, Mass., U.S.A. Alternatively, the motion processor 36 is any other circuit, device or system capable of receiving the timing signal 29, deriving the motion profile from the received timing signal 29, and comparing the derived motion profile to the predesignated motion profile P to generate the control signal 25. The motion processor 36 uses the timing of the amplitude transitions within the timing signal 29 to derive the motion profile of the optical element 18. When the predesignated motion profile P is a velocity profile as shown in FIG. 2C, the derived motion profile is a velocity profile that indicates the velocity of the optical element. When the predesignated motion profile P is an acceleration profile, the derived motion profile is an acceleration profile, indicating the acceleration of the optical element. When the predesignated motion profile P is a jerk profile, the derived motion profile is a jerk profile indicating the jerk of the optical element. The motion processor 36 performs the comparison between the derived motion profile and the predesignated motion profile P in order to generate the control signal that enables the deviation between derived motion profile and the predesignated motion profile P to be minimized and causes the motion of the optical element 18 to conform to the predesignated motion profile P.

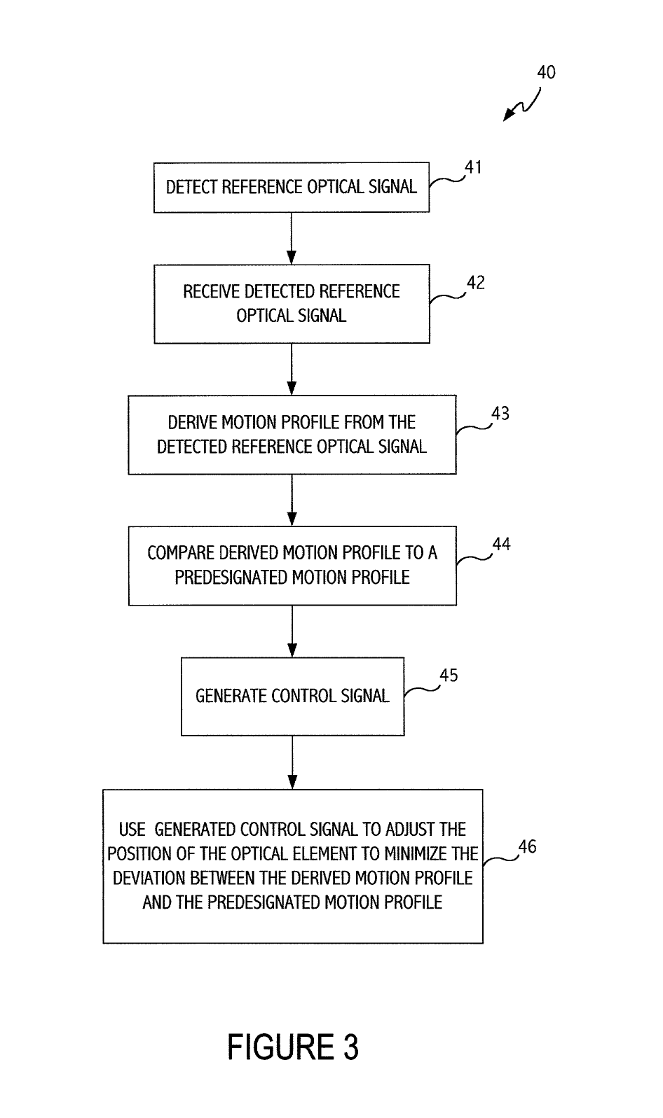

In an alternative embodiment of the present invention, the feedback position control system 20 is implemented according to a method. FIG. 3 is a flow diagram of a feedback position control method 40 constructed according to a second embodiment of the present invention. The feedback position control method 40 includes detecting a reference optical signal that varies in intensity according to a position of an optical element in a variable arm of the interferometer (step 41), receiving the detected reference optical signal (step 42) and deriving a motion profile from the detected reference optical signal (step 43). The feedback position control method 40 then includes comparing the derived motion profile to a predesignated motion profile (step 44), generating a control signal based on a deviation between the derived motion profile and the predesignated motion profile (step 45) and using the control signal to adjust the position of the optical element in the variable arm of the interferometer to minimize the deviation between the derived motion profile and the predesignated motion profile (step 46).

While the embodiments of the present invention have been illustrated in detail, it should be apparent that modifications and adaptations to these preferred embodiments may occur to one skilled in the art without departing from the scope of the present invention as set forth in the following claims.

What is claimed is:

1. A position control system for an interferometer, comprising:
a photodetector detecting a reference optical signal varying in intensity according to a position of an optical element in a variable arm of the interferometer;
a feedback processor coupled to the photodetector, receiving the detected reference optical signal, deriving a motion profile from the detected reference optical signal, comparing the derived motion profile to a predesignated motion profile and generating a control signal based on a deviation between the derived motion profile and the predesignated motion profile; and
an actuator, coupled to the feedback processor, receiving the control signal and adjusting the position of the optical element in the variable arm of the interferometer to minimize the deviation between the derived motion profile and the predesignated motion profile.

2. The position control system of claim 1 wherein the predesignated motion profile is one of a predesignated velocity profile, a predesignated acceleration profile, and a predesignated jerk profile, the derived motion profile being a derived velocity profile when the predesignated motion profile is a predesignated velocity profile, the derived motion profile being a derived acceleration profile when the predesignated motion profile is a predesignated acceleration profile, and the derived motion profile being a derived jerk profile when the predesignated motion profile is a predesignated jerk profile.

3. The position control system of claim 1 wherein the feedback processor includes a waveform conditioner receiving the detected reference optical signal and generating a timing signal with amplitude transitions that correspond to the position of the optical element in the variable arm, and a motion processor receiving the generated timing signal, establishing the derived motion profile based on timing of the amplitude transitions within the timing signal and comparing the derived motion profile to the predesignated motion profile to generate the control signal.

4. The position control system of claim 2 wherein the feedback processor includes a waveform conditioner receiving the detected reference optical signal and generating a timing signal with amplitude transitions that correspond to the position of the optical element in the variable arm, and a motion processor receiving the generated timing signal, establishing the derived motion profile based on timing of the amplitude transitions within the timing signal and comparing the derived motion profile to the predesignated motion profile to generate the control signal.

5. The position control system of claim 3 wherein the waveform conditioner includes a squaring circuit making the timing signal a square wave.

6. The position control system of claim 5 wherein the waveform conditioner includes a frequency divider scaling the timing of the amplitude transitions within the timing signal.

7. The position control system of claim 4 wherein the waveform conditioner includes a squaring circuit making the timing signal a square wave.

8. The position control system of claim 7 wherein the waveform conditioner includes a frequency divider scaling the timing of the amplitude transitions within the timing signal.

9. A position control method for an interferometer, comprising:
detecting a reference optical signal that varies in intensity according to a position of an optical element in a variable arm of the interferometer;
receiving the detected reference optical signal;
deriving a motion profile from the detected reference optical signal;
comparing the derived motion profile to a predesignated motion profile;
generating a control signal based on a deviation between the derived motion profile and the predesignated motion profile; and
using the control signal to adjust the position of the optical element in the variable arm of the interferometer to minimize the deviation between the derived motion profile and the predesignated motion profile.

10. The position control method of claim 11 wherein the predesignated motion profile is one of a predesignated velocity profile, a predesignated acceleration profile, and a predesignated jerk profile, the derived motion profile being a derived velocity profile when the predesignated motion profile is a predesignated velocity profile, the derived motion profile being a derived acceleration profile when the predesignated motion profile is a predesignated acceleration profile, and the derived motion profile being a derived jerk profile when the predesignated motion profile is a predesignated jerk profile.
